(19) United States
(12) Patent Application Publication
(10) Pub. No.: US 2007/0110007 A1
(43) Pub. Date: May 17, 2007

(54) Method for operating a radiocommunication system

(75) Inventors: Patricia Bertram, Munchen (DE); Christina Gessner, Munchen (DE); Christian Klaussner, Munchen (DE); Stephan Laue, Munchen (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, 80333 MUNICH (DE)

(21) Appl. No.: 10/554,938

(22) PCT Filed: Mar. 31, 2004
(86) PCT No.: PCT/EP04/50396

§ 371 Date: Nov. 6, 2006

(30) Foreign Application Priority Data
Apr. 29, 2003 (DE) 103 19 311.1

(51) Int. Cl. H04Q 7/24

(52) U.S. Cl. 370/338; 455/458

(57) ABSTRACT

A radiocommunication system has a downward link radio channel associated with each upward link radio channel, respectively. A subscriber station receives data from a radio station on a network side to the downward link radio channel, with no logic liaison being established between the subscriber station and the radio station on the network side. A message is sent by the subscriber station on the upward link radio channel associated with the downward link radio channel. Said message is emitted by the radio station on the network side via the downward link radio station.

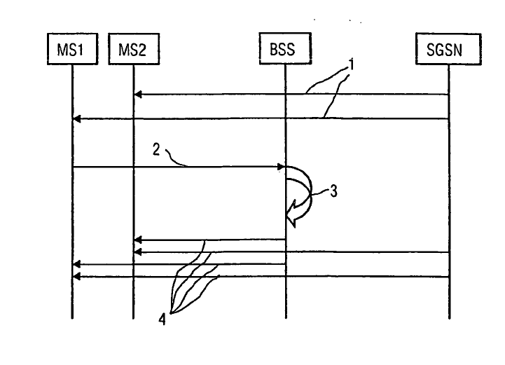

Radiocommunication systems are used for transmitting information, speech or data, using electromagnetic waves via a radio interface between a transmitting and a receiving radio station. One example of a radiocommunication system is the familiar GSM mobile radiocommunication network, together with its development GPRS, the architecture of which is described, for example, in B. Walke, Mobilfunknetze und ihre Protokolle [Mobile radiocommunication networks and their protocols], Vol. 1, Teubner-Verlag, Stuttgart, 1998, pp. 139 to 151 and pp. 295 to 311. Here, a channel comprising a narrowband frequency range and a time-slot is provided in each case for the transmission of a subscriber signal.

For the purpose of communicating packet data, a radio communication system, for example a GSM mobile radio-communication network with GPRS, incorporates a multitude of packet data service nodes (Serving GPRS Support Node, SGSN), which are networked with each other and which create the access to a fixed data network. For circuit-switched data transmission, the radiocommunication system incorporates mobile exchanges which are networked with each other and which create the access to a fixed network. The packet data service nodes and the mobile exchanges are in addition connected to base station controllers (BSCs). In turn, each base station controller enables a connection to be made to at least one base station (BTS), and undertakes the administration of the radio resources of the connected base stations. A base station and base station controller are referred to as a base station system. A base station is a transmit/receive unit which can set up a communication link to subscriber stations via a radio interface. In this case, one radio channel from the base station to the subscriber station is referred as a downward radio channel or the downlink radio channel, and one radio channel from the subscriber station to the base station as an upward radio channel or the uplink radio channel.

A distinction is made between two operating modes of a subscriber station: in the quiescent state, for which the term “idle mode” is usual in the technical field, there is no logical connection between the subscriber station and a base station. In the dedicated state, also commonly referred to by the term “dedicated mode”, there is a logical connection between the subscriber station and a base station, in which a dedicated channel is assigned to the subscriber station, over which message transmission can take place.

New types of data services have been proposed in which a radio station, for example a base station, sends out data without this data being assigned to a special connection. Rather, the data is transmitted like a broadcast transmission, and can be received by all the subscriber stations present in the radio communication network, in particular those within the radio reach of the base station or a defined group of subscriber stations present in the radiocommunication system. The receiving subscriber stations can in this case be in the quiescent state, i.e. idle mode. These services include also the service proposed for the GERAN standard and the UTRAN standard under the term “Multimedia Broadcast Multicast Services”, abbreviated to “MBMS”.

Potential subscribers to data services of this type can have themselves registered in the radiocommunication system. They are then given an identifier and can be assigned as a group to certain signaling channels, for example as a paging group to a paging channel. Accounting for these services is effected via the registration.

In these data services, the data is transmitted exclusively by a network-side radio station. That is to say, the radio channels used are exclusively in the downward direction. In radio communication systems, for example, conforming to or similar to the GERAN standard, one radio channel in the upward direction has in each case a fixed assignment to one radio channel in the downward direction. In this case, only the radio channel in the downward direction is used for these data services.

It has been proposed that the assigned radio channel in the upward direction is used in the MBMS service for counting the subscribers on a special channel with optional access, or for normal data in the upward direction (see for example GP-030667, 3GPP TSG GERAN#14 Meeting).

The problem underlying the invention is that of specifying a method for operating a radiocommunication system in which radio channels in the upward direction and radio channels in the downward direction are used efficiently.

This problem is solved by a method in accordance with claim 1. Further embodiments of the invention derive from the remaining subclaims.

In a radiocommunication system in which in each case one radio channel in the upward direction and one radio channel in the downward direction are assigned to each other, a subscriber station receives data, which has been transmitted by a net-work-side radio station via a radio channel in the downward direction, without a logical connection being set up between the subscriber station and the network-side radio station. The network-side radio station may take the form, for example, of a base station with a base station controller. The data may be, for example, data for an MBMS service. The subscriber station sends a message via a radio channel, in the upward direction, which is assigned to the radio channel in the downward direction over which the data is sent. The network-side radio station transmits this message via the radio channel in the downward direction.

By this means, the message can also be received by all the subscribers which receive the data which is transmitted by the network-side radio station via the channel in the downward direction. The message could be, for example, a comment about the data received. For example, if the data received represents a video clip, the message could contain feedback on the video clip.

It falls within the scope of the invention for a subscriber station to extract, from a signaling message from the network-side radio station, the parameters of the assigned radio channel in the upward direction. Alternatively, the subscriber station may determine the parameters of the assigned radio channel in the upward direction on the basis of the parameters of the radio channel in the downward direction.

Preferably, the message over the radio channel in the downward direction will be transmitted with a lower priority than that of the transmission of the data via the radio channel in the downward direction. This will ensure that it is possible to adhere to the real time requirement applying to the transmission of the data via the radio channel in the downward direction.

Preferably, the message will be reflected in the network-side radio station, and transmitted over the radio channel in the downward direction in multiplexed form together with the data. In doing this, the message will be received in the network-side radio station and together with the data will be transmitted by the network-side radio station, via the radio channel in the downward direction. One advantage of this approach consists in the fact that the remainder of the radio-communication system is not burdened with the message. It is then conceivable, in particular, that no charges will be levied for a message which only gets as far as the network-side radio station.

Here, it falls within the scope of the invention for the message to be given an identifier which indicates that the network-side radio station is not to transmit the message towards a core network of the radiocommunication system. This identifier ensures that the network-side radio station will in turn transmit the message via the channel in the downward direction, without the message getting into the core network.

This identifier could, for example, be entered into the radio link control medium access control protocol.

The message can be transmitted from the subscriber station to the network-side radio station without a logical connection being set up between the radio station and the network-side radio station, i.e. when the subscriber station is in the quiescent state, or the so-called idle mode.

In addition, the message can be transmitted between the subscriber station and the network-side radio station if a connection has been set up in the upward direction, between the subscriber station and the network-side radio station, for the purpose of packet data transmission.

Furthermore, a special type of connection can be provided in the radiocommunication system, reserved for the type of messages which are transmitted in the upward direction via radio channels which are assigned to radio channels in the downward direction over which data is transmitted without a logical connection being set up between the transmitting network-side radio station and the subscriber stations which receive the data.

It falls within the scope of the invention for the extent of the message to be restricted. One effect of this, for example, can be to limit the number of messages transmitted per subscriber per time interval or per data transmission. In addition, rules can be set down for the individual subscribers. The object of this would be to prevent individual subscribers from making excessive use of the radio channel in the upward direction. The subscriber stations must be notified in advance of these limitations or rulings, by signaling.

The method permits an interactivity between subscribers with-out the need for a dedicated connection between the network-side radio station and the subscriber stations. The method can be applied without the involvement of the core network. By appropriate prioritization of the messages it is possible to avoid a negative effect on the data transmission in the radio channel in the downward direction. The method is suitable for all data transmissions which are made without a logical connection between a subscriber station and a network-side radio station. The receipt and the retransmission of the message requires neither processing of the data nor a subscriber identification.

The method is explained in more detail below by reference to an example which is shown in the FIGURE.

The FIGURE shows a message flow in a radiocommunication system.

In a radio communication system, designed for example according to or similarly to the GERAN standard, in an MBMS service 1 a packet-switching unit SGSN transmits data via a base station system BSS incorporating a base station controller BSC and a base station BTS. A first subscriber station MS1 and a second subscriber station MS2 receive the data transmitted by the MBMS service 1, without a logical connection existing between the first subscriber station MS1 or the second subscriber station MS2, as applicable, and the base station system BSS. The first subscriber station MS1 transmits to the base station system BSS a message which, for example, contains feedback about the data received, via a radio channel in the upward direction which is assigned to the radio channel in the downward direction via which the data for the MBMS service 1 was transmitted.

In the base station system BSS, the message 2 undergoes a diversion 3. To effect this, an identifier is entered for the message in the radio link control medium access control protocol, indicating that this message is not to be transmitted to the packet-switching unit SGSN. In the base station system BSS, the message 2 is multiplexed with the data for the MBMS service 1, transmitted to the base station system BSS by the packet-switching unit SGSN, and is transmitted to the first subscriber station MS1 and the second subscriber station MS2 in a shared transmission 4, via the channel in the downward direction.

When this is done, the priority of the message 2 is less than that of the data for the MBMS service 1, so that real-time requirements of the MBMS service 1 continue to be met. Both the subscriber station MS1 and the subscriber station MS2 can now receive the data for the MBMS service 1 and the message 2. In this way, the message 2 is made available to all the subscriber stations which receive the data for the MBMS service 1.

Since the message 2 has been diverted in the base station system BSS without reaching the packet-switching unit SGSN or going beyond it into the radiocommunication system, the receipt, the diversion and the transmission of the message 2 can be effected without charge. This service is then included in the charge levied for the MBMS service 1. In the base station system BSS, the message 2 is in no way identified. It is diverted transparently. Just like the data for the MBMS service 1 it is transmitted in undirected form, like a radio broadcast transmission.

1-8. (canceled)

9. A method for operating a radio communication system, comprising:
assigning each radio channel in an upward direction to a corresponding radio channel in a downward direction;
receiving data at a subscriber station which was transmitted from a network-side radio station via a radio channel in the downward direction, the data being received without a logical connection being set up between the subscriber station and the network-side radio station;
transmitting a message from the subscriber station via a radio channel in the upward direction which is assigned to the radio channel via which the data was received, the message commenting on the data received ; and
retransmitting the message from the network-side radio station via the radio channel in the downward direction that was used to transmit the data, the message being retransmitted with no involvement by a core network of the radio communication system.

10. The method in accordance with claim 9, wherein the subscriber station identifies the radio channel in the upward direction which is assigned to the radio channel via which the data was received, by:
extracting parameters associated with the radio channel in the upward direction from a signaling message received from the network-side radio station, or
determining the parameters associated with the radio channel in the upward direction from parameters associated with the radio channel in the downward direction.

11. The method in accordance with claim 9, wherein the message is retransmitted via the radio channel in the downward direction, with a lower priority than transmission of data via the radio channel in the downward direction.

12. The method in accordance with claim 9, wherein when the message is retransmitted from the network-side radio station, the message is multiplexed with the data and transmitted via the radio channel in the downward direction.

13. The method in accordance with claim 12, wherein
the message has an identifier which indicates that the message should not be transmitted by the network-side radio station towards the core network of the radio communication system.

14. The method in accordance with claim 9, wherein the message is transmitted from the subscriber station to the network-side radio station without a logical connection being set up between the subscriber station and the network-side radio station.

15. The method in accordance with claim 9, wherein a connection is set up between the subscriber station and the network-side radio station for purposes of transmitting packet data, via which the message is transmitted.

16. The method in accordance with claim 9, wherein there is a restriction on the extent to which messages can be transmitted by a subscriber station and retransmitted by the network-side radio station.

17. The method in accordance with claim 10, wherein the message is retransmitted via the radio channel in the downward direction, with a lower priority than transmission of data via the radio channel in the downward direction.

18. The method in accordance with claim 17, wherein when the message is retransmitted from the network-side radio station, the message is multiplexed with the data and transmitted via the radio channel in the downward direction.

19. The method in accordance with claim 18, wherein
the message has an identifier which indicates that the message should not be transmitted by the network-side radio station towards the core network of the radio communication system.

20. The method in accordance with claim 19, wherein the message is transmitted from the subscriber station to the network-side radio station without a logical connection being set up between the subscriber station and the network-side radio station.

21. The method in accordance with claim 20, wherein there is a restriction on the extent to which messages can be transmitted by a subscriber station and retransmitted by the network-side radio station.

22. The method in accordance with claim 19, wherein a connection is set up between the subscriber station and the network-side radio station for purposes of transmitting packet data, via which the message is transmitted.

23. The method in accordance with claim 22, wherein there is a restriction on the extent to which messages can be transmitted by a subscriber station and retransmitted by the network-side radio station.
